(19) United States
(12) Patent Application Publication
(10) Pub. No.: US 2006/0120457 A1
(43) Pub. Date: Jun. 8, 2006

(54) Method and apparatus for encoding and decoding video signal for preventing decoding error propagation

(76) Inventors: Seung Wook Park, Sungnam-si (KR); Ji Ho Park, Sungnam-si (KR); Byeong Moon Jeon, Sungnam-si (KR)

Correspondence Address: HARNESS, DICKEY & PIERCE, P.L.C., P.O. BOX 8910, RESTON, VA, 20195, US

(21) Appl. No.: 11/293,131

(22) Filed: Dec. 5, 2005

Related U.S. Application Data
(60) Provisional application No. 60/632,978, filed on Dec. 6, 2004.

(30) Foreign Application Priority Data
Mar. 25, 2005 (KR) 10-2005-0024983

(51) Int. Cl. H04N 11/02; H04N 11/04; H04N 7/12; H04B 1/66

(52) U.S. Cl. 375/240.16; 375/240.24

(57) ABSTRACT

A method and apparatus for encoding and decoding a video signal according to a Motion Compensated Temporal Filtering (MCTF) scheme is provided. A video frame sequence divided into video intervals is encoded over a plurality of levels of a temporal decomposition procedure of MCTF. A reference block of an image block included in an initial one of the frames of each decomposition level belonging to a current video interval is searched for in both an L frame obtained at the last level of a temporal decomposition procedure of a video interval immediately prior to the current video interval and a frame included in the current video interval, and an image difference between the image block and the reference block is coded into the image block. This prevents a decoding error of the initial frame at each temporal composition level caused by an increase in the number of temporal composition levels over video intervals.

### PRIORITY INFORMATION

This application claims priority under 35 U.S.C. §119 on Korean Patent Application No.10-2005-0024983, filed on Mar. 25, 2005, the entire contents of which are hereby incorporated by reference.

This application also claims priority under 35 U.S.C. §119 on U.S. Provisional Application No. 60/632,978, filed on Dec. 6, 2004, the entire contents of which are hereby incorporated by reference.

### BACKGROUND OF THE INVENTION

1. Field of the Invention

The present invention relates to scalable encoding and decoding of a video signal, and more particularly to a method and apparatus for encoding a video signal according to a scalable Motion Compensated Temporal Filtering (MCTF) scheme so as to prevent propagation of decoding errors at the boundaries of video intervals such as group of pictures (GOPs) and a method and apparatus for decoding such encoded video data.

2. Description of the Related Art

It is difficult to allocate high bandwidth, required for TV signals, to digital video signals wirelessly transmitted and received by mobile phones and notebook computers, which are widely used, and by mobile TVs and handheld PCs, which it is believed will come into widespread use in the future. Thus, video compression standards for use with mobile devices must have high video signal compression efficiencies.

Such mobile devices have a variety of processing and presentation capabilities so that a variety of compressed video data forms must be prepared. This indicates that the same video source must be provided in a variety of forms corresponding to a variety of combinations of a number of variables such as the number of frames transmitted per second, resolution, and the number of bits per pixel. This imposes a great burden on content providers.

Because of these facts, content providers prepare high-bitrate compressed video data for each source video and perform, when receiving a request from a mobile device, a process of decoding compressed video and encoding it back into video data suited to the video processing capabilities of the mobile device before providing the requested video to the mobile device. However, this method entails a transcoding procedure including decoding and encoding processes, which causes some time delay in providing the requested data to the mobile device. The transcoding procedure also requires complex hardware and algorithms to cope with the wide variety of target encoding formats.

The Scalable Video Codec (SVC) has been developed in an attempt to overcome these problems. This scheme encodes video into a sequence of pictures with the highest image quality while ensuring that part of the encoded picture sequence (specifically, a partial sequence of frames intermittently selected from the total sequence of frames) can be decoded and used to represent the video with a low image quality. Motion Compensated Temporal Filtering (MCTF) is a scheme that has been suggested for providing a temporally scalable feature to the scalable video codec.

FIG. 1 illustrates how a video signal is encoded according to a general MCTF scheme.

In FIG. 1, the video signal is composed of a sequence of pictures denoted by numbers. A prediction operation is performed for each odd picture with reference to adjacent even pictures to the left and right of the odd picture so that the odd picture is coded into an error value corresponding to image differences (also referred to as a “residual”) of the odd picture from the adjacent even pictures. In FIG. 1, each picture coded into an error value is marked ‘H’. The error value of the H picture is added to a reference picture used to obtain the error value. This operation is referred to as an update operation. In FIG. 1, each picture produced by the update operation is marked ‘L’. The prediction and update operations are performed for pictures (for example, pictures 1 to 16 in FIG. 1) in a given Group of Pictures (GOP), thereby obtaining 8 H pictures and 8 L pictures. The prediction and update operations are repeated for the 8 L pictures, thereby obtaining 4 H pictures and 4 L pictures. The prediction and update operations are repeated for the 4 L pictures. Such a procedure is referred to as temporal decomposition, and the Nth level of the temporal decomposition procedure is referred to as the Nth MCTF (or Temporal Decomposition (TD)) level, which will be referred to as level N for short. All H pictures obtained by the prediction operations and an L picture 101 obtained by the update operation at the last level for the single GOP in the procedure of FIG. 1 are then transmitted.

The procedure for decoding a received video frame, encoded in the encoding procedure of FIG. 1, is performed in the opposite order to that of the encoding procedure. As described above, scalable encoding such as MCTF allows video to be viewed even with a partial sequence of pictures selected from the total sequence of pictures. Thus, when decoding is performed, the extent of decoding can be adjusted based on the transfer rate of a transmission channel, i.e., the amount of video data received per unit time. Typically, this adjustment is made on a per GOP basis, and reduces the number of levels of Temporal Composition (TC), which is the inverse of temporal decomposition, when the amount of information is insufficient and increases the number of levels of temporal composition when the amount of information is sufficient.

FIG. 2 illustrates how a video signal encoded as shown in FIG. 1 is decoded. In the example of FIG. 2, a temporal composition procedure is performed on frames of a certain GOP (GOP,) up to the second level (TC:1→TC:2) due to an insufficient amount of received information, and a temporal composition procedure is performed on frames of a next GOP (GOPₙ₊₁) up to the highest (i.e., fourth) level (TC:1→TC:2→TC:3→TC:4).

However, the increase in the number of levels of the temporal composition procedure at the GOP boundary causes an error when decoding a frame close to the GOP boundary and the error propagates to near frames.

In the example of FIG. 2, temporal composition is performed on encoded frames of the current GOP (GOPₙ) up to the second level (TC:1→TC:2), so that an L frame L100, which has been obtained at the first temporal decomposition level (TD:1) in the encoding procedure, is not produced. Then, temporal composition is performed on encoded frames of the next GOP (GOPₙ₊₁) up to the fourth level (TC:1→TC:2→TC:3→TC:4). This process fails to normally reconstruct an L frame L12 from an H frame H22 due to absence of the L frame L100 in the GOP (GOPₙ) necessary for the reconstruction, so that the decoded L frame L12 contains an error. Frames 1 and 3 reconstructed from the first two H frames H11 and H13 obtained at the first level of the temporal decomposition procedure also contains errors since the L frame L12 containing an error is referred to for the reconstruction. Consequently, in the example of FIG. 2, the first three frames 1, 2, and 3 of the GOP (GOPₙ₊₁) are decoded into video frames containing errors, thereby lowering the image quality.

The greater the increase in the number of temporal composition levels at the GOP boundary, the more serious the error propagation and the greater the number of decoded video frames containing errors, thereby significantly lowering the image quality.

### SUMMARY OF THE INVENTION

Therefore, the present invention has been made in view of the above problems, and it is an object of the present invention to provide a method and apparatus for encoding a video signal in a scalable fashion while dividing the video signal into video intervals such as GOPs over which the extent of decoding may vary, which prevents video reconstruction errors caused by changes in the extent of decoding at boundaries of the video intervals, and a method and apparatus for decoding such encoded data stream.

In accordance with the present invention, the above and other objects can be accomplished by the provision of an apparatus for encoding a video frame sequence divided into video intervals through a temporal decomposition procedure, wherein a reference block of an image block included in at least one of a plurality of frames belonging to a current video interval is searched for in both an L frame obtained at the last level of a temporal decomposition procedure of a video interval immediately prior to the current video interval and a frame included in the current video interval, and an image difference between the image block and the reference block is coded into the image block.

In an embodiment of the present invention, the video frame sequence is divided into groups of pictures (GOPs), and a temporal decomposition procedure is performed on each GOP.

In an embodiment of the present invention, a temporal decomposition procedure is performed on frames in each GOP until one L frame is obtained, and the L frame is used as a reference frame for coding frames in a next GOP into error values in a temporal decomposition procedure of the next GOP.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates a procedure for encoding a video signal according to an MCTF scheme;

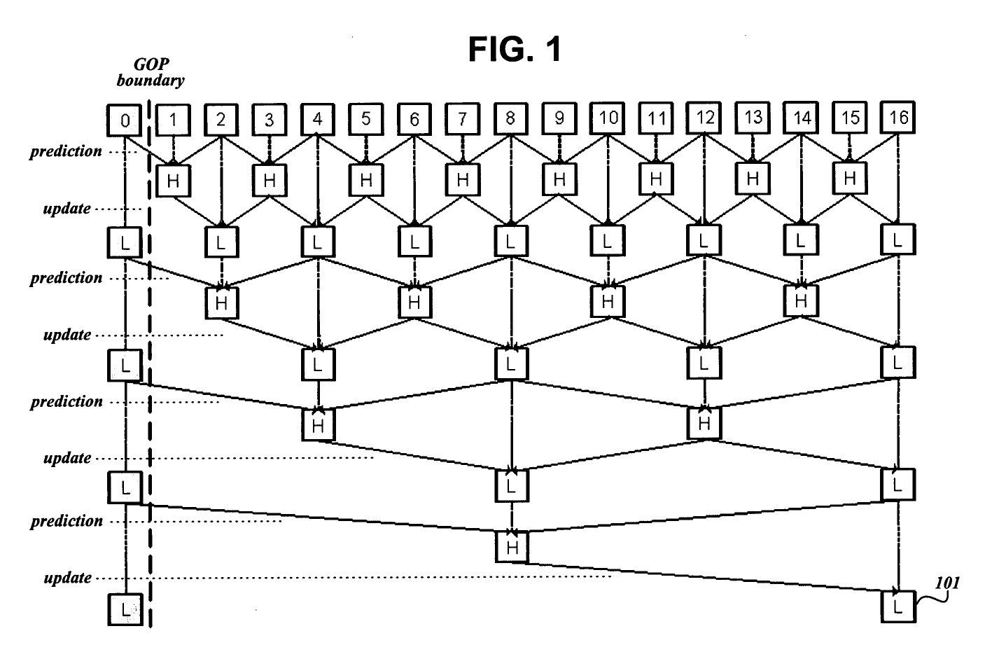

FIG. 2 illustrates propagation of an error occurring when decoding a frame encoded in the procedure of FIG. 1;

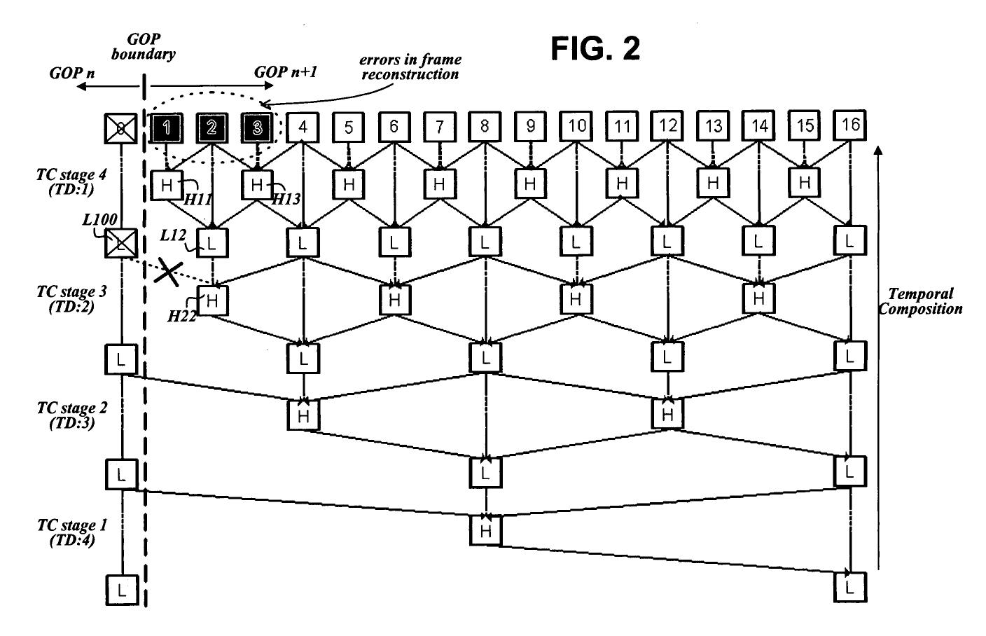

FIG. 3 is a block diagram of a video signal encoding apparatus to which a video signal coding method according to the present invention is applied;

FIG. 4 illustrates main elements of an MCTF encoder of FIG. 3 for performing image prediction/estimation and update operations;

FIG. 5 illustrates a method for encoding a video signal in an MCTF scheme according to the present invention;

FIG. 6 is a block diagram of an apparatus for decoding a data stream encoded by the apparatus of FIG. 3; and

FIG. 7 illustrates main elements of an MCTF decoder of FIG. 6 for performing inverse prediction and update operations.

### DESCRIPTION OF THE PREFERRED EMBODIMENTS

Preferred embodiments of the present invention will now be described in detail with reference to the accompanying drawings.

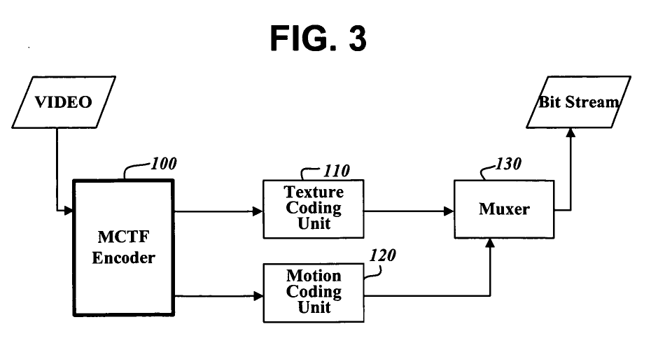

FIG. 3 is a block diagram of a video signal encoding apparatus to which a scalable video signal coding method according to the present invention is applied.

The video signal encoding apparatus shown in FIG. 3 comprises an MCTF encoder 100 to which the present invention is applied, a texture coding unit 110, a motion coding unit 120, and a muxer (or multiplexer) 130. The MCTF encoder 100 encodes an input video signal and generates suitable management information on a per macroblock basis according to an MCTF scheme. The texture coding unit 110 converts information of encoded macroblocks into a compressed bitstream. The motion coding unit 120 codes motion vectors of image blocks obtained by the MCTF encoder 100 into a compressed bitstream according to a specified scheme. The muxer 130 encapsulates the output data of the texture coding unit 110 and the output vector data of the motion coding unit 120 into a predetermined format. The muxer 130 then multiplexes and outputs the encapsulated data into a predetermined transmission format.

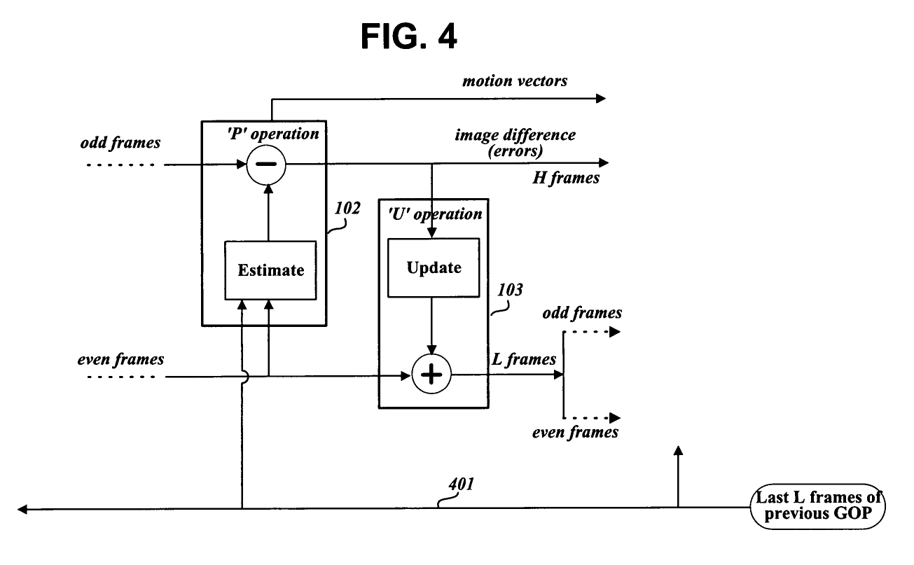

The MCTF encoder 100 performs motion estimation and prediction operations on each target macroblock in a video frame (or picture). The MCTF encoder 100 also performs an update operation by adding an image difference of the target macroblock from a reference macroblock in a reference frame to the reference macroblock. FIG. 4 illustrates main elements of the MCTF encoder 100 for performing these operations.

The MCTF encoder 100 divides an input video frame sequence into specific intervals, and then performs estimation/prediction and update operations on video frames in each interval a plurality of times (over a plurality of temporal decomposition levels). FIG. 4 shows elements associated with estimation/prediction and update operations at one of the plurality of temporal decomposition levels. Although the embodiments of the present invention will be described with reference to GOPs as the specific intervals, the present invention can also be applied when a video signal is divided into intervals, each including a smaller or larger number of frames than a predetermined number of frames of each GOP. That is, when intervals over which the extent of decoding may vary are defined, the present invention can be applied to frames prior to and subsequent to boundaries of the intervals, regardless of the number of frames of each interval.

The elements of the MCTF encoder 100 shown in FIG. 4 include an estimator/predictor 102 and an updater 103. Through motion estimation, the estimator/predictor 102 searches for a reference block of each target macroblock of a frame, which is to be coded to residual data, in a neighbor frame prior to or subsequent to the frame. The estimator/predictor 102 then performs a prediction operation on the target macroblock in the frame by calculating both an image difference (i.e., a pixel-to-pixel difference) of the target macroblock from the reference block and a motion vector of the target macroblock with respect to the reference block. The updater 103 performs an update operation for a macroblock, whose reference block has been found in an adjacent frame by the motion estimation, by normalizing and adding the image difference of the macroblock to the reference block. The operation carried out by the updater 103 is referred to as a ‘U’ operation, and a frame produced by the ‘U’ operation is referred to as an ‘L’ frame. The ‘L’ frame is a low-pass subband picture.

The estimator/predictor 102 and the updater 103 of FIG. 4 may perform their operations on a plurality of slices, which are produced by dividing a single frame, simultaneously and in parallel instead of performing their operations on the video frame. A frame (or slice), which is produced by the estimator/predictor 102, is referred to as an ‘H’ frame (or slice). The difference value data in the ‘H’ frame (or slice) reflects high frequency components of the video signal. In the following description of the embodiments, the term ‘frame’ is used in a broad sense to include a ‘slice’, provided that replacement of the term ‘frame’ with the term ‘slice’ is technically equivalent.

More specifically, the estimator/predictor 102 divides each input video frame (or each L frame obtained at the previous level) into macroblocks of a predetermined size, and searches for a reference block having a most similar image to that of each divided macroblock in temporally adjacent frames at the same temporal decomposition level, and then produces a predictive image of the macroblock based on the reference block and obtains a motion vector of the divided macroblock with respect to the reference block. Particularly, for the first (or initial) frame at each temporal decomposition procedure in a video frame group (for example, a GOP), an image block most similar to that of a macroblock in the first frame is searched for in an L frame at the last temporal decomposition level in a previous GOP rather than in a frame at the same temporal decomposition level in the previous GOP.

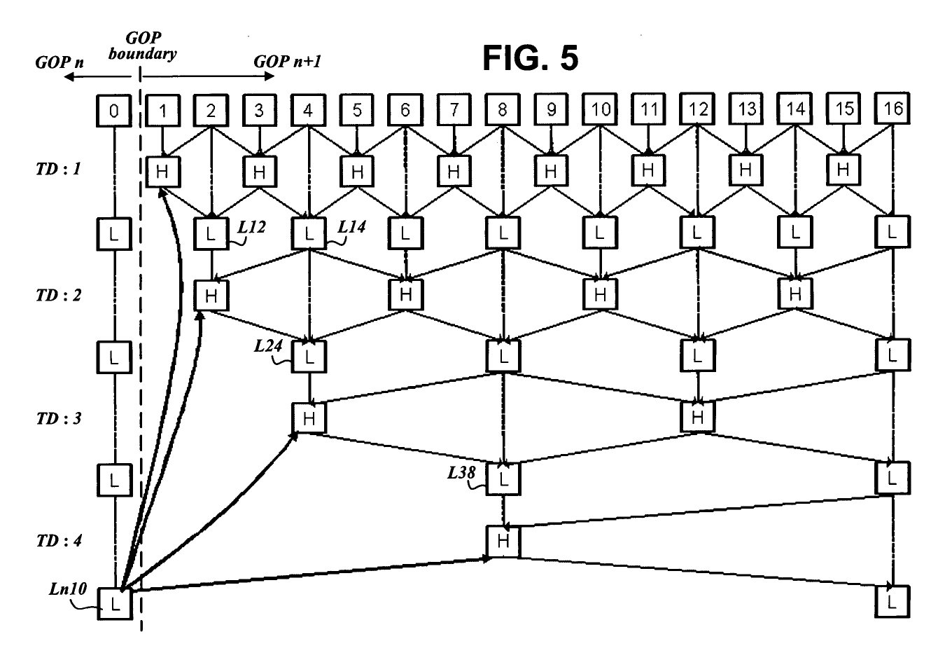

FIG. 5 illustrates how frames belonging to a GOP are coded into L frames and H frames according to an embodiment of the present invention. The operation of the estimator/predictor 102 will now be described in detail with reference to FIG. 5.

The estimator/predictor 102 converts odd frames (Frame 1, 3, and 5) from among input video frames (or input L frames) to H frames having error values. For this conversion, the estimator/predictor 102 divides a current frame into macroblocks, and searches for a macroblock, most highly correlated with each of the divided macroblocks, in frames (or L frames) prior to and subsequent to the current frame. The block most highly correlated with a target block is a block having the smallest image difference from the target block. The image difference of two image blocks is defined, for example, as the sum or average of pixel-to-pixel differences of the two image blocks. Of blocks having a predetermined threshold pixel-to-pixel difference sum (or average) or less from the target block, a block(s) having the smallest difference sum (or average) is referred to as a reference block(s).

When it is necessary to search not only a current GOP (GOPₙ₊₁) but also a previous GOP (GOPₙ) for reference blocks of a current frame to be converted into an error value (or residual), for example, when encoding first frames 1, L12, L24, or L38 (shown in FIG. 5) for conversion into an H frame, the estimator/predictor 102 searches for reference blocks in an L frame Ln10 obtained at the last temporal decomposition level (TD:4) of the previously encoded GOP (GOPₙ), rather than in an adjacent frame at the same level of the previous GOP (GOPₙ) as the current temporal decomposition level.

Thus, according to the present invention, when encoding of frames of a GOP is completed to produce an L frame and H frames, the L frame (or an L frame temporally closest to a next GOP when a plurality of L frames is produced) is stored and the stored L frame is provided for encoding of frames of the next GOP (401).

Although arrows are drawn in FIG. 5 to avoid complicating the drawings as if a reference block used for conversion of a given L frame into an H frame is searched for in two adjacent L frames prior to and subsequent to the given L frame, the reference block can also be searched for in a plurality of adjacent L frames prior to the given L frame and in a plurality of adjacent L frames subsequent thereto. In this case, reference blocks of frames (for example, frames 3 and L14 in FIG. 5), other than the first frames 1, L12, L24, and L38 of the temporal decomposition levels, can also be searched for not only in frames in the current GOP (GOPₙ₊₁) but also in frames in the previous GOP (GOPₙ) However, the frame in the previous GOP (GOPₙ), in which the reference blocks of the frames other than the first frames 1, L12, L24, and L38 of the temporal decomposition levels are to be searched for, must be limited to the last L frame Ln10 at the last level of the temporal decomposition procedure of the previous GOP (GOPₙ), which has been stored in the encoding procedure of the previous GOP (GOPₙ).

If a reference block of a target macroblock in the current L frame is found, the estimator/predictor 102 obtains a motion vector originating from the target macroblock and extending to the reference block and transmits the motion vector to the motion coding unit 120. If one reference block is found in a frame, the estimator/predictor 101 calculates errors (i.e., differences) of pixel values of the target macroblock from pixel values of the reference block and codes the calculated errors into the target macroblock. If a plurality of reference blocks is found in a plurality of frames, the estimator/predictor 102 calculates errors (i.e., differences) of pixel values of the target macroblock from pixel values obtained from the reference blocks, and codes the calculated errors into the target macroblock. Then, the estimator/predictor 102 inserts a block mode value of the target macroblock according to the selected reference block (for example, one of the mode values of Skip, DirInv, Bid, Fwd, and Bwd modes) in a field at a specific position of a header of the target macroblock.

An H frame, which is a high-pass subband picture having an image difference (residual) corresponding to the current L frame, is completed upon completion of the above procedure for all macroblocks of the current L frame. This operation performed by the estimator/predictor 102 is referred to as a ‘P’ operation.

Then, the updater 103 performs an operation for adding an image difference of each macroblock of a current H frame to an L frame having a reference block of the macroblock as described above. If a macroblock in the current H frame has an error value which has been obtained using, as a reference block, a block in an L frame at the last decomposition level of the previous GOP (or in the last L frame at the last decomposition level in the case where a plurality of L frames is produced per GOP), the updater 103 does not perform the operation for adding the error value of the macroblock to the L frame of the previous GOP.

A data stream including H and L frames encoded in the method described above is transmitted by wire or wirelessly to a decoding apparatus or is delivered via recording media. The decoding apparatus reconstructs an original video signal of the encoded data stream according to the method described below.

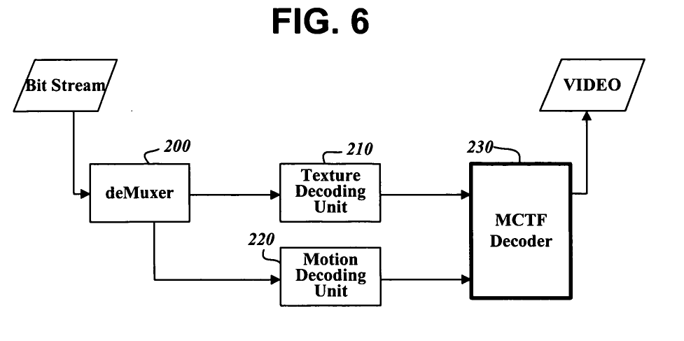

FIG. 6 is a block diagram of an apparatus for decoding a data stream encoded by the apparatus of FIG. 3. The decoding apparatus of FIG. 6 includes a demuxer (or demultiplexer) 200, a texture decoding unit 210, a motion decoding unit 220, and an MCTF decoder 230. The demuxer 200 separates a received data stream into a compressed motion vector stream and a compressed macroblock information stream. The texture decoding unit 210 reconstructs the compressed macroblock information stream to its original uncompressed state. The motion decoding unit 220 reconstructs the compressed motion vector stream to its original uncompressed state. The MCTF decoder 230 converts the uncompressed macroblock information stream and the uncompressed motion vector stream back to an original video signal according to an MCTF scheme.

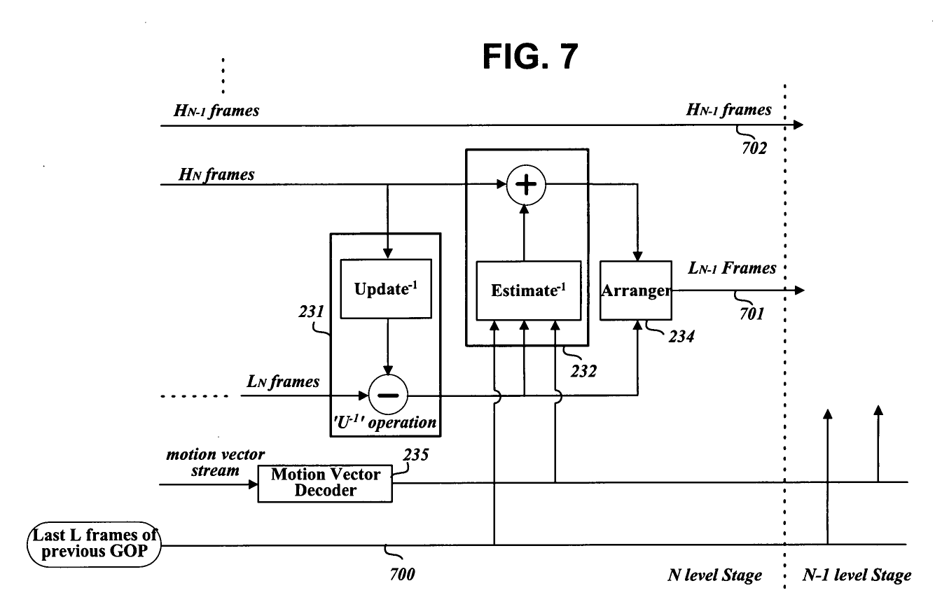

The MCTF decoder 230 reconstructs an original frame sequence from an input stream. FIG. 7 illustrates main elements of the MCTF decoder 230 responsible for temporal composition of a sequence of H and L frames of temporal decomposition level N into an L frame sequence of temporal decomposition level N-1.

The elements of the MCTF decoder 230 shown in FIG. 7 include an inverse updater 231, an inverse predictor 232, a motion vector decoder 235, and an arranger 234. The inverse updater 231 selectively subtracts pixel difference values of input H frames from pixel values of input L frames. The inverse predictor 232 reconstructs input H frames to L frames having original images using the H frames and the L frames, from which the image differences of the H frames have been subtracted. The motion vector decoder 235 decodes an input motion vector stream into motion vector information of blocks in H frames and provides the motion vector information to an inverse predictor (for example, the inverse predictor 232) of each stage. The arranger 234 interleaves the L frames completed by the inverse predictor 232 between the L frames output from the inverse updater 231, thereby producing a normal sequence of L frames (or a final video frame sequence). L frames output from the arranger 234 constitute an L frame sequence 701 of level N-1. A next-stage inverse updater and predictor of level N-1 reconstructs the L frame sequence 701 and an input H frame sequence 702 of level N-1 to an L frame sequence. This decoding process is performed the same number of times as the number of MCTF levels employed in the encoding procedure, thereby reconstructing an original video frame sequence.

In the meantime, the MCTF decoder 230 divides a frame sequence in a received data stream into groups of frames (for example, GOPs) and stores a copy of an L frame (or a last one of a plurality of L frames) in each GOP, and then performs a temporal composition procedure. The stored copy of the L frame is used in a temporal composition procedure of frames in the next GOP.

A more detailed description will now be given of how H frames of level N are reconstructed to L frames according to the present invention. First, for an input L frame, the inverse updater 231 performs an operation for subtracting error values (i.e., image differences) of macroblocks in all H frames, whose image differences have been obtained using blocks in the L frame as reference blocks, from the blocks of the L frame. However, when an image difference of a macroblock in an H frame has been obtained with reference to a block in an L frame in a different GOP, the inverse updater 231 does not perform the operation for subtracting the image difference of the macroblock from the L frame.

For each macroblock in a current H frame, the inverse predictor 232 locates a reference block of the macroblock in an L frame with reference to a motion vector provided from the motion vector decoder 235, and reconstructs an original image of the macroblock by adding pixel values of the reference block to difference values of pixels of the macroblock. If motion vector information of a macroblock in the current H frame points to a frame in a previous GOP rather than a frame in the current GOP, the inverse predictor 232 reconstructs an original image of the macroblock using a reference block in a stored copy of an L frame belonging to the previous GOP. Such a procedure is performed for all macroblocks in the current H frame to reconstruct the current H frame to an L frame. The reconstructed L frame is provided to the next stage through the arranger 234.

The above decoding method reconstructs an MCTF-encoded data stream to a complete video frame sequence. As described above, the last L frame of the previous GOP can always be received and used for temporal composition of the current GOP regardless of up to which level the temporal composition procedure is performed on the previous GOP. Accordingly, no error is caused by absence of pixel values of reference blocks required for temporal composition of the current GOP even if temporal composition is performed on the current GOP up to a higher level than the previous GOP (for example, up to the same level as the number of decomposition levels).

The decoding apparatus described above can be incorporated into a mobile communication terminal, a media player, or the like.

As is apparent from the above description, the present invention provides a method and apparatus for encoding and decoding a video signal divided into video intervals in a scalable fashion, which prevents error data caused by absence of reference blocks when reconstructing frames close to boundaries of video intervals such as GOPs over which the extent of decoding varies, thereby preventing a reduction in the image qualities of the frames close to the boundaries of the video intervals.

Although this invention has been described with reference to the preferred embodiments, it will be apparent to those skilled in the art that various improvements, modifications, replacements, and additions can be made in the invention without departing from the scope and spirit of the invention. Thus, it is intended that the invention cover the improvements, modifications, replacements, and additions of the invention, provided they come within the scope of the appended claims and their equivalents.

What is claimed is:

1. An apparatus for encoding a video frame sequence divided into video intervals through a temporal decomposition procedure, the apparatus comprising:
first means for searching for a reference block of an image block included in at least one of a plurality of frames belonging to an arbitrary video interval in both a specific frame included in a video interval immediately prior to the arbitrary video interval and a frame included in the arbitrary video interval, and coding an image difference between the image block and the reference block into the image block; and
second means for selectively performing an operation for adding the image difference between the image block and the reference block to the reference block,
wherein the specific frame includes a frame obtained at a last level of a temporal decomposition procedure of the immediately prior interval.

2. The apparatus according to claim 1, wherein the reference block includes a block having the smallest image difference value from the image block from among a plurality of blocks having a predetermined threshold difference value or less from the image block.

3. The apparatus according to claim 1, wherein the at least one frame includes an initial frame of each level of a temporal decomposition procedure of the arbitrary video interval.

4. The apparatus according to claim 1, wherein the specific frame includes a low-pass video frame.

5. The apparatus according to claim 1, wherein the specific frame includes a frame temporally closest to the arbitrary video interval from among a plurality of low-pass video frames.

6. The apparatus according to claim 1, wherein each of the video intervals allows a change in the number of levels of an inverse procedure of the temporal decomposition procedure of the video interval when the inverse procedure of the video interval is performed in a decoding procedure.

7. The apparatus according to claim 6, wherein each of the video intervals includes a group of pictures (GOP).

8. The apparatus according to claim 1, wherein the second means does not perform the operation for adding the image difference between the image block and the reference block to the reference block if the reference block is found in the specific frame.

9. A method for encoding a video frame sequence divided into video intervals through a temporal decomposition procedure, the method comprising:
searching for a reference block of an image block included in at least one of a plurality of frames belonging to an arbitrary video interval in both a specific frame included in a video interval immediately prior to the arbitrary video interval and a frame included in the arbitrary video interval, and coding an image difference between the image block and the reference block into the image block; and
selectively performing an operation for adding the image difference between the image block and the reference block to the reference block,
wherein the specific frame includes a frame obtained at a last level of a temporal decomposition procedure of the immediately prior interval.

10. The method according to claim 9, wherein the reference block includes a block having the smallest image difference value from the image block from among a plurality of blocks having a predetermined threshold difference value or less from the image block.

11. The method according to claim 9, wherein the at least one frame includes an initial frame of each level of a temporal decomposition procedure of the arbitrary video interval.

12. The method according to claim 9, wherein the specific frame includes a low-pass video frame.

13. The method according to claim 9, wherein the specific frame includes a frame temporally closest to the arbitrary video interval from among a plurality of low-pass video frames.

14. The method according to claim 9, wherein each of the video intervals allows a change in the number of levels of an inverse procedure of the temporal decomposition procedure of the video interval when the inverse procedure of the video interval is performed in a decoding procedure.

15. The method according to claim 14, wherein each of the video intervals includes a group of pictures (GOP).

16. The method according to claim 9, wherein the operation for adding the image difference between the image block and the reference block to the reference block is not performed if the reference block is found in the specific frame.

17. An apparatus for receiving and decoding an encoded frame sequence into a video signal, the apparatus comprising:
first means for subtracting difference values of pixels of a target block included in a frame belonging to an arbitrary frame group in the frame sequence from a reference block which has been used to obtain the difference values of the pixels of the target block if the reference block is present in a frame belonging to the arbitrary frame group; and
second means for reconstructing an original image of a target block including pixels having difference values present in at least one frame belonging to the arbitrary frame group using pixel values of a reference block of the target block present in a specific frame in a frame group immediately prior to the arbitrary frame group,
wherein the specific frame includes a frame obtained at a last level of a temporal decomposition procedure of the immediately prior frame group.

18. The apparatus according to claim 17, wherein the second means specifies the reference block of the target block based on information of a motion vector of the target block.

19. The apparatus according to claim 17, wherein the at least one frame includes an initial frame of each level of a temporal composition procedure of the arbitrary frame group.

20. The apparatus according to claim 17, wherein the specific frame includes a low-pass video frame.

21. The apparatus according to claim 17, wherein the specific frame includes a frame temporally closest to the arbitrary video group from among a plurality of low-pass video frames.

22. The apparatus according to claim 17, wherein each of the frame groups corresponds to a group of pictures (GOP).

23. The apparatus according to claim 17, wherein the at least one frame includes a frame at a different temporal decomposition level from the specific frame.

24. The apparatus according to claim 17, wherein the first means does not subtract the difference values of the pixels of the target block from the reference block if the reference block is present in the specific frame.

25. A method for receiving and decoding an encoded frame sequence into a video signal, the method comprising:
subtracting difference values of pixels of a target block included in a frame belonging to an arbitrary frame group in the frame sequence from a reference block which has been used to obtain the difference values of the pixels of the target block if the reference block is present in a frame belonging to the arbitrary frame group; and
reconstructing an original image of a target block including pixels having difference values present in at least one frame belonging to the arbitrary frame group using pixel values of a reference block of the target block present in a specific frame in a frame group immediately prior to the arbitrary frame group,
wherein the specific frame includes a frame obtained at a last level of a temporal decomposition procedure of the immediately prior frame group.

26. The method according to claim 25, wherein the reference block of the target block is specified based on information of a motion vector of the target block.

27. The method according to claim 25, wherein the at least one frame includes an initial frame of each level of a temporal composition procedure of the arbitrary frame group.

28. The method according to claim 25, wherein the specific frame includes a low-pass video frame.

29. The method according to claim 25, wherein the specific frame includes a frame temporally closest to the arbitrary video group from among a plurality of low-pass video frames.

30. The method according to claim 25, wherein each of the frame groups corresponds to a group of pictures (GOP).

31. The method according to claim 25, wherein the at least one frame includes a frame at a different temporal decomposition level from the specific frame.

32. The method according to claim 25, wherein the difference values of the pixels of the target block is not subtracted from the reference block if the reference block is present in the specific frame.
